(19) United States
(12) Patent Application Publication
(10) Pub. No.: US 2002/0194444 A1
(43) Pub. Date: Dec. 19, 2002

(54) System and method for managing out-of-order memory access requests via an age-shifted index

(75) Inventors: Earl Ronald Goodrich II, East Lansing, MI (US); Harold Joesph Wilson, Center Valley, PA (US)

Correspondence Address: HITT GAINES & BOISBRUN P.C., P.O. BOX 832570, RICHARDSON, TX, 75083, US

(73) Assignee: TelGen Corporation, Lansing, MI (US)

(21) Appl. No.: 09/880,994

(22) Filed: Jun. 14, 2001

(51) Int. Cl. G06F 13/00

(52) U.S. Cl. 711/167; 711/154

(57) ABSTRACT

A system for, and method of, managing out-of-order memory access requests and a memory unit incorporating the system or the method. In one embodiment, the system includes: (1) a shift register for containing memory addresses and associated request validity indicators corresponding to a plurality of memory access requests and (2) control logic, coupled to the shift register, for modifying a validity indicator for a selected one of the memory access requests, the modifying causing the selected one of the memory access requests to be removed from the shift register.

### TECHNICAL FIELD OF THE INVENTION

The present invention is directed, in general, to memory access techniques and, more specifically, to a system and method that employs an age-shifted index to manage out-of-order memory access requests and concomitant memory accesses.

### BACKGROUND OF THE INVENTION

As the speed and number of processors in computer systems continue to increase, the accessibility and sharing of memory resources becomes an important aspect in the design of computer systems. An efficient memory controller and system bus that can provide fast response to memory requests are essential.

Many system buses are of the split-transaction type. In a split-transaction bus, each transaction on the system bus is split into multiple phases. By overlapping phases of different transactions, bus performance is improved in general.

Split transaction buses further allow out-of-order replies to requests made by multiple sources. Each request has a transaction ID, and transactions on the bus are matched by their transaction BDs, not by the order in which they appear on the bus. This mechanism increases throughput on the system bus because requested, information can be retrieved in parallel.

A memory controller is used to control the information and data that is exchanged between the system bus and main memory. A memory controller typically includes a memory command queue that buffers incoming memory commands. Read and write data buffers act as temporary storage for data read from or to be written to the main memory. The main memory in microprocessor based computer systems is typically comprised of Dynamic Random Access Memories (DRAMs). DRAM cells contain multiple rows and columns. DRAMs are controlled by applying a row address to one or more DRAMs, activating a Row Address Strobe signal (RAS) that starts access to a selected row, waiting during the row address access time, applying a column address to the DRAMs, and then activating the Column Address Strobe signal (CAS) to select the data from one column of the selected row.

In a page mode DRAM, each access command includes a memory address (where data is stored), a RAS and a CAS. The RAS and CAS control the timing of DRAMs to latch the row and column addresses. As employing the same row address saves row address access and potentially pre-charge time, page mode allows repeated access to the same row for faster access to a memory location if that memory location has the same row address as the previous memory access command. Clearly, because of the page-mode features of DRAMs, it is advantageous to access many storage locations in a single row before changing the row address.

However, in typical microprocessor-based computer systems, data are read from and written to memory at random addresses, so the advantages of page mode operation often cannot be realized.

Conventional memory controllers use a variety of implementations to increase the throughput and response of the system. Some memory controller implementations with one or more microprocessors ignore queuing issues and place the memory sharing onus back on the primary requesters. While this approach works, it is inflexible and becomes complex as the size of the system increases. Another approach to implementation of a memory controller places single or multiple FIFO (First In First Out) request queues at the head of each memory bank. While more flexible than implementations without queues, FIFO requires duplications of queue logic across the memory banks.

To further maximize throughput, some memory controllers attempt to re-order the queues to mitigate the timing impact of random requests and thus take advantage of page mode operations of DRAMs.

Accordingly, what is needed in the art is a more efficient way to manage out-of-order memory access requests than a FIFO buffer.

### SUMMARY OF THE INVENTION

To address the above-discussed deficiencies of the prior art, the present invention provides a system for, and method of, managing out-of-order memory access requests and a memory unit incorporating the system or the method. In one embodiment, the system includes: (1) a shift register for containing memory addresses and associated request validity indicators corresponding to a plurality of memory access requests and (2) control logic, coupled to the shift register, for modifying a validity indicator for a selected one of the memory access requests, the modifying causing the selected one of the memory access requests to be removed from the shift register.

The present invention therefore introduces the broad concept of employing a shift register to remove invalid memory access requests from a request queue and thereby removes the need for complicated counters to manage control for a request storage array.

In one embodiment of the present invention, the control logic causes the selected one of the memory access requests to be removed from the shift register. In an alternative embodiment, the selected one of the memory accesses temporarily remains in the shift register, but is subject to erasure when the shift register subsequently shifts and collapses.

In one embodiment of the present invention, the shift register at least partially shifts to replace the selected one of the memory access requests. In an alternative embodiment, the shift register may not at least partially shift to replace, but instead may shift when an invalidate request reaches the register, thereby physically removing the invalid request.

In one embodiment of the present invention, a memory associated with the system contains validity indicators corresponding to addressable locations therein. The control logic may employ the validity indicators in the memory in conjunction with the validity indicators in the shift registers to further manage priority and aging with respect to memory accesses.

In one embodiment of the present invention, the system further includes a memory request buffer, associated with the shift register, for containing data corresponding to the plurality of memory access requests. Alternatively, the data may be contained along with the addresses in the shift register.

In one embodiment of the present invention, the validity indicator is a one bit flag. Alternative embodiments may call for more levels of priority or invalidity and therefore may call for greater numbers of bits in the validity indicator.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a simplified block diagram of a microprocessor based computer system that includes a memory subsystem;

FIG. 2 illustrates a block diagram of the memory controller;

FIG. 3 illustrates details of the aging technique in the shift register;

FIG. 4 illustrates a diagram of a bank state machine;

FIG. 5 depicts the associated request decision logic; and

FIG. 6 illustrates a diagram of a Global Control State Machine.

### DETAILED DESCRIPTION

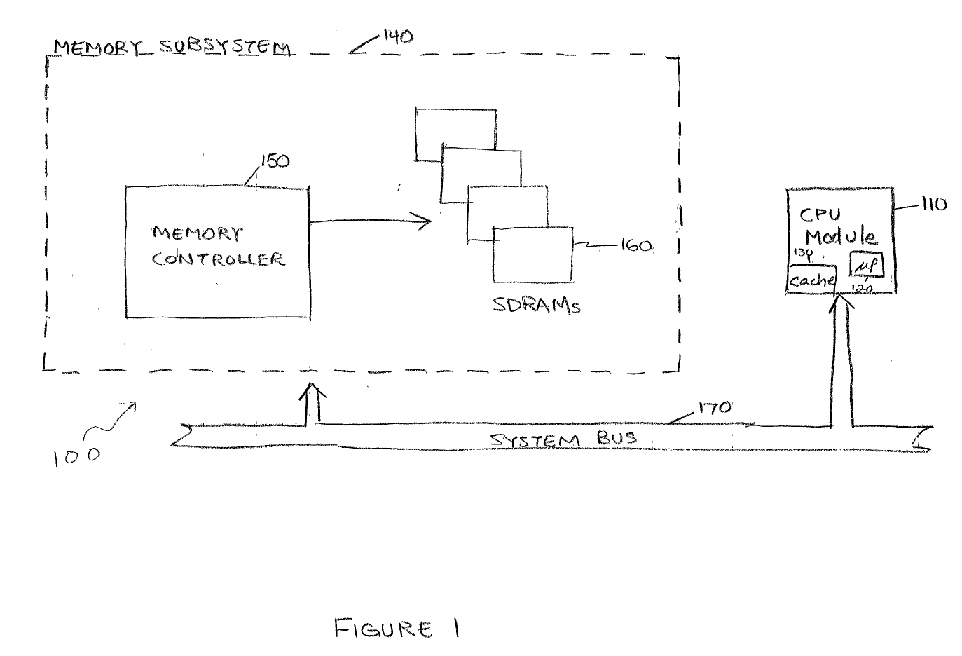

FIG. 1 is a block diagram illustrating portions of an exemplary microprocessor based computing system 100 according to one illustrative embodiment of the present invention. Computing system 100 includes one or more CPU modules 110 which include a microprocessor 120 and a cache memory 130. CPU module 110 also includes other conventional circuitry such as a bus controller and bus interface which is not shown. CPU module 110 communicates with a memory subsystem 140 via a system bus 170. Memory subsystem 140 includes a memory controller 150 and a plurality of Synchronous Dynamic Random Access Memories (SDRAMs) 160. Computer system 100 may include other components such as disk drives and disk drive controllers, an I/O interface, video displays, keyboards and the like which are not shown in FIG. 1. It should be understood that other such components may access memory subsystem 140 using direct memory access (DMA) transactions via system bus 170. Additionally, computer system 100 may be employed in a communication processing platform, such as described in U.S. patent application Ser. No. 09/860886, entitled “Distributed Communication Device Architecture For Balancing Processing Of Real-Time Communications,” filed, May 18, 2001, incorporated herein by reference.

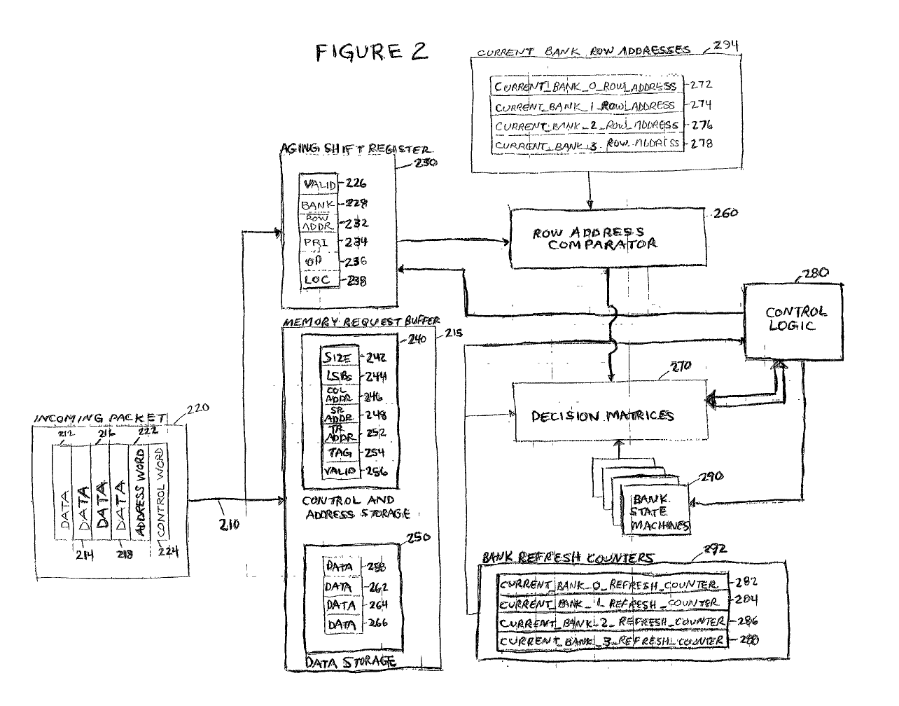

FIG. 2 depicts a block diagram of a memory controller 150 of an exemplary embodiment of the present invention. Memory controller 150 comprises an optional memory request buffer 215, a shift register 230, a validity indicator 226, control logic 280, a set of row address comparators 260, bank state machines 290, decision matrices 270, current bank refresh counters 292, and current bank row addresses 294.

Memory controller 150 manages out-of-order memory access requests on line 210. Memory request buffer 215 contains data corresponding to the plurality of memory access requests. Shift register 230 contains memory addresses and associated request validity indicators 226 which correspond to a plurality of memory access requests. Shift register 230 is at least as many bits wide as necessary to represent the SRAM addresses, plus an individually resettable validity indicator 226 that indicates the associated storage location contains valid request information. The total length of shift register 230 matches the total queue length.

Control logic 280, coupled to the shift register 230, modifies validity indicator 226 for a selected memory access request, causing said memory access request to be removed from the shift register 230. Control logic 280 can cause a full or partial shift of the shift register 230. Refresh requests come from the current bank refresh counters 292, while the current bank row addresses 294 are used by the row address comparators 260 for sensing pagemode operations for memory.

Aging shift register 230 includes bit storage for the validity indicator 226, bank selection bits 228, row address 232, priority 234, opcode 236, and location pointer 238. Memory request buffer 215 includes the control and address storage registers 240 with bit storage for size 242, address LSBs 244, column address 246, transaction source ID 248, and transaction source tag 254. The data storage registers 250 are 32 bits wide, and store up to four 32-bit data words 258, 262, 264, and 266 for each request. Request buffer 215 may be implemented as more shift register bits directly connected with each shift register location 230, but in the preferred embodiment it is a simpler static RAM store indexed by location pointers 238 in shift registers 230. The current bank refresh counters 292 comprise individual registers for Current_Bank_0_Refresh_Counter 282, Current_Bank_1_Refresh_Counter 284, Current_Bank_2_Refresh_Counter 286, and Current_Bank_3_Refresh_Counter 288. The current bank row addresses 294 comprise individual registers for the current row address of each bank: Current_Bank_0_Row_Address 272, Current_Bank_1_Row_Address 274, Current_Bank_2_Row_Address 276, Current_Bank_3_Row_Address 278.

Memory access requests enter memory controller 150 as a series of incoming packets 220 to the memory request buffer 215. The series of incoming packets 220 begins with a control word 224, followed by an address word 222, and an optional sequence of up to four data words 218, 216, 214, and 212. The important bits that are directly needed for decision-making are placed into the top word aging shift register 230. These bits include the validity indicator 226, bank selection bits 228, row address 232, priority 234, opcode 236, and location pointer 238.

The 3-bit wide command opcode 236 is coded from the switch inputs and works with the following encoding: 000 for Write Linear, 001 for Write Wraparound; 010 for Read Linear; 011 for Read Wraparound, and 111 for Read-then-Write. The priority bit 234 is used to force a bank to transition immediately to the associated page in memory. The rest of the control word and address information are placed in storage registers 240. This storage is indexed by the location pointer 238 in the top word aging shift register 230. Also indexed by location pointer 238 is an array of data storage locations 250 for holding data associated with a write request. As the write data is received from input 210, it is indexed into corresponding locations in registers 250. The information in registers 240 and 250 are not needed until the operation is in progress.

When a memory access request enters memory controller 150, the control word 224 is split as necessary into the bits for the top word aging shift register 230 and those bits in the control and address storage registers 240. Next, when the address word 222 is received, the two words in the aging shift register 230 and control and address storage registers 240 are completed and stored. The memory system will “wake up” when the control word is recognized and the request will be considered valid when the address is clocked in. The associated validity indicator 226 is set as the former contents (and the contents of all contiguous “valid” locations to the “right”) are shifted en-masse to make room for the new request. This right shifting of shift register 230 collapses one or more of the unused locations. Unused locations, or “holes”, will be created by out-of-order invalidation. If there were no room in shift register 230, i.e., if there were no un-used locations, the incoming request would have been stalled at the input to memory controller 150.

Memory controller 150 can use and invalidate any location in shift register 230 as required, as the control logic 280 allows that not all shift register locations shift on every clock. In the preferred embodiment, only contiguous ‘valid’ locations, starting from the input port end at the ‘left’ are shifted together when a memory access request is stored. Alternatively, an invalidation request can directly call for a shift of registers 230 to remove a finished request from the queue.

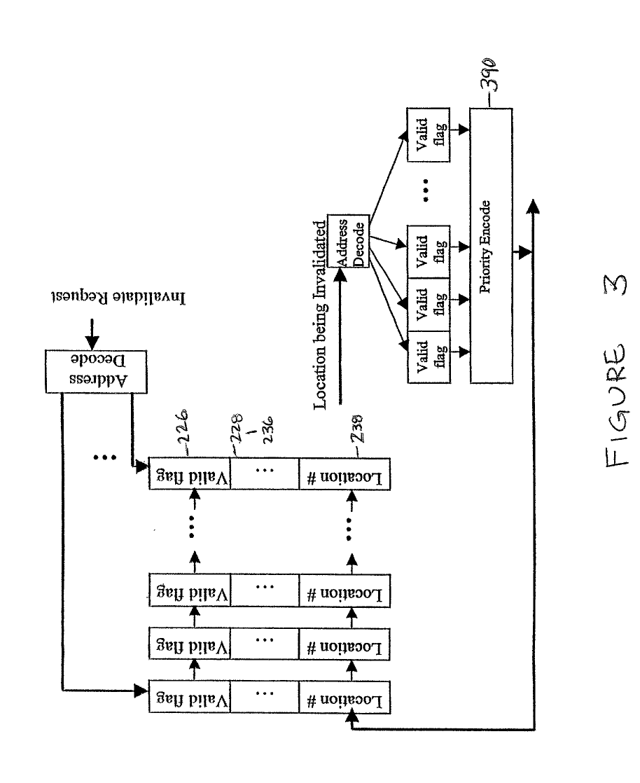

FIG. 3 shows more detail on the usage of the valid flags described above for aging shift register 230 and how, in the preferred embodiment, location numbers 238 can be used to index into registers 240 and 250. These index values are generated using logic derived directly from their own set of valid flags 256. That is, each storage location in 240 (of number matching the total queue length) has associated with it another valid bit 256 for the processes of keeping track of the used locations in this register storage. The reason for the location pointer 238 and this separate valid bit handling is to allow storage locations 240 and 250 to be implemented in very inexpensive and compact memory arrays (with independent read and write access ports), as opposed to the more complicated aging shift register logic 230. This is possible because only one word needs to be written, and one read, at any one time. Valid flags 256 allow the system to keep track of the presence of active information at any associated address in a location pointer 238 so that new information can be sure to be stored only in inactive locations. The location pointers 238 that shift within the aging shift register 230 and the independent valid flags 256 allow the auxiliary data in registers 240 and 250 to be retained in static storage until needed when the associated memory request becomes the active transaction.

As shown in FIG. 3, when a register in aging shift register 230 is being invalidated as a result of the completion of the associated request, the location pointer 238 of that particular register will be used as an index to invalidate the associated request buffer valid flag 256, thus ‘freeing up’ that address for reuse. A simple priority encoder 390 selects an address from among the available free locations to present to the storage logic in 230 to become the next location pointer 238 for the next memory request as the associated information is shifted in on the ‘left’. Accordingly, that same pointer value will be used as the pointer to store information into registers 240 and, if appropriate, write data storage 250.

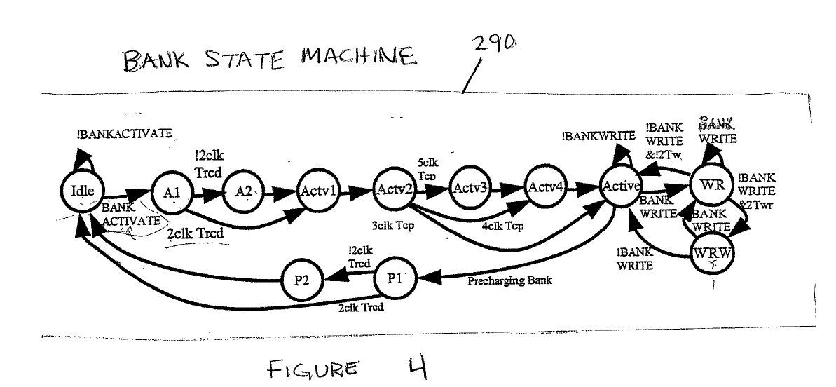

FIG. 4 details a bank state machine 290 which tracks the current state of one of the internal banks of SDRAM 160 and dictates to decision matrices 270 what operations are valid during the next clock for that bank. SDRAM devices have, internal to them, a number of relatively independent banks. In the preferred embodiment, there are four such banks. The progress of this state machine is driven using signals from control logic 280. The state machine is also controlled by a number of configuration parameters that will be preset to match the timing requirements of the attached S DRAM. This is a synchronous state machine running on the same clock signal as the SDRAM devices.

Referring to FIG. 4, each memory bank has an associated bank state machine. Each state machine includes the following states: Idle, A1, A2, Actv1, Actv2, Actv3, Actv4, WR, WRW, P1, and P2. In any of the five active states (Actv1, Actv2, Actv3, Actv4 or Active) or the two write states (WR or WRW), the bank is open and available for Read/Write commands. The Active state is the only state in which Precharge is allowed to ensure total Row Cycle Trc and writeback time are met.

While in the Idle state, if the BANKACTTVATE signal is not valid, the state machine remains in the Idle state. When the BANKACTIVATE signal is valid, the state changes from Idle to state A1. If the SDRAM timing setup requires a 2 clock RAS-to-CAS Trcd delay, the state changes from state A1 to state A2. If the SDRAM timing setup does not require a 2 clock RAS-to-CAS Trcd, the state changes directly to state Actv1. If the state machine goes through A2, it will next proceed from state A2 to state Actv1.

The state machine next moves from state Actv1 to state Actv2. State machine configuration parameters allow for support of a range of SDRAM technologies and include a 3/4/5 clock CAS to Precharge delay Tcp. On a 5 clock CAS to Precharge delay Tcp, the state changes from Actv2 to Actv3, where it will next change from state Actv3 to state Actv4. On a 4 clock CAS to Precharge delay Tcp, the state changes directly from Actv2 to Actv4. A change from Actv4 to Active will follow. If the SDRAM setup calls for a 3 clock CAS to Precharge delay Tcp, the state changes from Actv2 directly to Active. This sequence of states ensures that enough clock cycles pass between the BANKACTIVATE operation and any possible precharge, which is allowed only from the Active state.

When the bank state machine 290 is in the Active state, a number of things can occur. If the BANKWRITE signal is not valid, the state machine remains in the Active state. If the BANKWRITE signal is valid, the state changes from Active to the WR state. From the Active state, if the Precharging Bank signal is valid, the state changes from Active to state P1.

When the bank state machine is in either the WR state or the WRW state, the bank is still open and available for Read/Write commands. When in the WR state, as long as the BANKWRITE signal is valid, the state machine remains in the WR state. If the BANKWRITE signal is not valid, and 2Twr writeback timing is set up, the state transitions from the WR state to the WRW state. If the BANKWRITE signal is not valid and only one writeback clock is called for, the state transitions from the WR state back to the Active state.

When in the WRW state, if the BANKWRITE signal is valid, the state changes back to the WR state. When in the WRW state, if BANKWRITE signal is not valid, the state transitions to the Active state. These operations in WR and WRW ensure that after a data write to this bank, enough time is allowed for the data to fully propagate internally before a precharge can be allowed for the associated bank.

When a precharge has been called for from the Active state so that the state machine is in the P1 state, then if a 2 clock RAS-to-CAS Trcd is sufficient (as this timing parameter is assumed to also apply to precharge time requirements, although it could just as easily be a separate timing parameter setup), the state changes from state P1 to Idle. If the SDRAM setup does not call for a 2 clock RAS-to-CAS Trcd (and thus means 3 clocks) then it will require an extra clock cycle getting through P2.

These per-bank state conditions are one of the kinds of information fed into the decision matrices 270. The other key information is collected from the ‘important’ information which is stored in the aging shift register 230 and correspondingly the outputs of the row address comparators 260. In order for the ‘out-of-order’ process to work, the decision matrices require simultaneous access to all the bits in all the valid shift register locations 230 and the row address comparators associated with each one of them. That is to say, each register in 230 has associated logic that will pick the appropriate current row register from 272, 274, 276 or 278 as dictated by the stored bank bits 228, and do a logical comparison for equality with comparators 260 against the stored request row address bits 232, and present the results to decision matrices 270. This will give the page-fit/miss information needed by the out-of-order request evaluation logic.

Most importantly in the design of any shared-access memory subsystem is the requirement that all entities requesting service receive a consistent view of the memory contents based on the actual order received. It is specifically necessary for any write request that correlates to a pending read request be processed first if it arrived earlier. A simple controller will do this by processing the requests in the received order regardless of efficiency. It is the key job of a more sophisticated controller such as this to give that same result to the external interfaces while internally altering the order of operations to improve memory system throughput. In this environment it is deemed sufficient that an address that matches the same memory page could be in conflict, so that memory requests within a page are ensured to proceed in the order received. It is the exact purpose of the aging shift register to maintain incoming requests in the order received. While requests can be ‘pulled’ from any location, decision matrices 270 work with the page match outputs from the row address comparators 260 to process a group of requests that all involve the same page all together (to maximize pagemode efficiency) and strictly in the order received.

Refresh is also a very critical function for any DRAM system. It is the goal of the decision criteria to get refresh requests to ‘find’ their way into an available time where the bank becomes idle (and thus are normally the lowest priority operation). Refresh counters 282, 284, 286, and 288 are ‘ticked’ at a rate appropriate for the SDRAM requirements, and will call for a ‘refresh’ on a per-bank basis as required. However, if a second refresh ‘tick’ arrives without the first being served, then the refresh is called ‘critical’ and must be done as soon as possible.

More specifically, for each bank, a decision matrix 270 evaluates the types of pending requests and the bank state machine 290 inputs to determine the ‘valid’ things that can be done to choose the most appropriate action. If the bank has a priority request in the queue, it must be considered next. If it is not a pagehit, the controller must get to that page. Once it is a pagehit, priority of individual pagehits do not matter at the bank level; the requests must be processed in order. In the absence of priority needs, the order of importance to perform falls to any pagehits, then other activity associated with new pages, followed by ordinary refresh requests. In summary, the criteria upon which these decisions are based (in order) are whether a critical (2 refresh ticks passed) refresh is needed with a bank Active or bank Idle, whether there is a priority page miss or priority Idle, whether there is a page hit or page miss, whether the bank is Idle, and whether a refresh is needed with the bank Active or Idle. If a critical refresh is needed and the bank is Active, request a precharge. If a critical refresh is needed and the bank is Idle, request activation from the refresh counter. If there is a priority pagemiss, request a precharge. If a priority operation is needed from Idle, request activation giving the priority mode address in shift register 230 where the row address can be found. If it is a pagehit, forward the type, priority, and location of the oldest matching location (‘rightmost’ matching location of shift register bank 230). If a refresh is needed and the bank is Active, request a precharge. If a refresh is needed and the bank is Idle, request activation from the refresh counter.

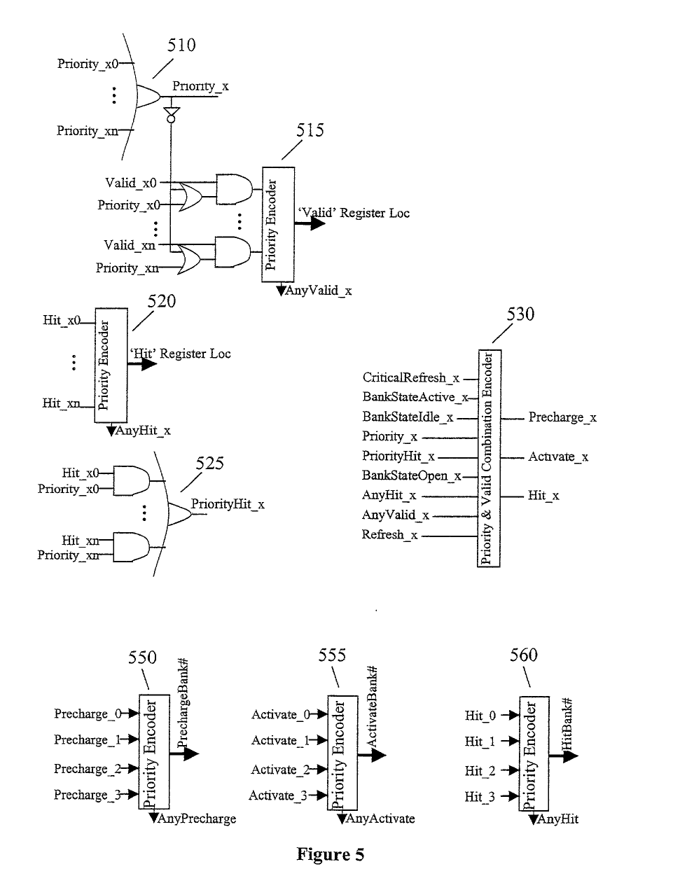

FIG. 5 is a functional diagram of an embodiment of the decision tree matrices 270. The ‘x’ at (or next to) the end of each signal name is to indicate one of the four possible bank numbers 0 through 3, as this logic is duplicated for each bank. The numbers ‘0’ to ‘n’ (and the intervening ellipses) indicate the entire collection of ‘n’+1 queue locations in aging shift register 230, which is the queue depth. Thus, we can see how ‘or’ gate 510 gets set if any queue contains a priority operation for this particular bank. The output of this gate also feeds gates leading into new-request encoder 515, and the purpose of this is to mask off any non-priority requests if a priority one exists for this bank to force immediate consideration of the priority request. Encoder 520 indicates a pagehit for bank ‘x’. Furthermore, these priority encoders 515 and 520 are set to provide the queue address within 230 that represents the oldest such new request or pagehit. Another set of gates 525 supplies direct indication of a priority pagehit. These outputs, along with the bank state machine 290 indications of Idle, Active, or Open (meaning any of the aforementioned states, detailed in FIG. 4, in which read and write commands may be issued) and the refresh inputs are considered in the previously described fashion by logic in block 530 to produce specific requests to precharge or activate a bank, or to proceed with a pagehit read or write operation. Each of these outputs will also trigger a source for the part of the request address that must accompany the operation, whether that is a refresh address, a row address from an indicated location in register 230 from encoder 515, or a column address indexed from storage 240 by location pointer 238 in aging shift register 230 from encoder 520.

Despite the fact that all logic to this point has been independently defined on a per-bank basis, the reality is that the memory subsystem can only perform one actual operation at a time, and there is some interaction among those operations. The task then falls to a set of global decision blocks 550, 555, and 560 and a global control state machine 600, to be described below, to coordinate each actual memory cycle. The global decision blocks 550, 555 and 560 can be as simple as priority encoders that just create a fixed order between multiple bank requests, although more sophisticated priority mechanisms can easily be implemented without departing from the spirit of the invention. The global state machine keeps track of actual memory bus command sequences and databus activities, and tries to block together reads and writes to keep the pipeline full. As this state machine proceeds to perform activities on individual memory banks, the individual bank state machines will update themselves accordingly.

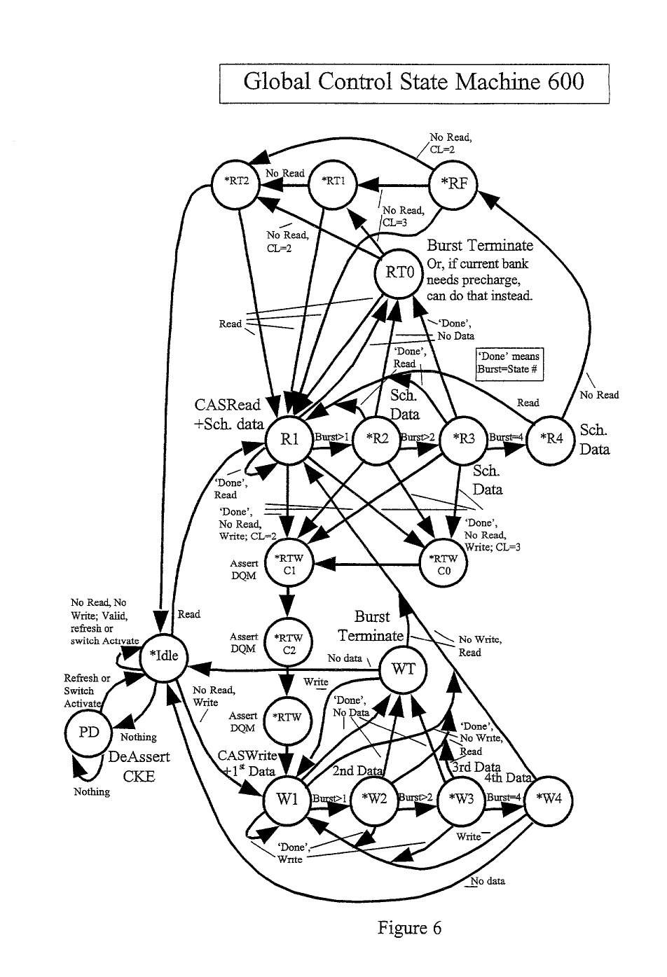

FIG. 6 illustrates a global control state machine 600. Global control state machine 600 drives and keeps track of memory control and databus states, while working with the inputs from the decision matrices 270 to keep the bank,s as busy as possible and minimize the read/write changeover and the databus direction change clock cycles involved. Global control state machine 600 includes the following states: Idle, PD, R1, R2, R3, R4, RF, RT0, RT1, RT2, RTWC0, RTWC1, RTWC2, RTW, W1, W2, W3, W4, and WT.

Although the present invention has been described in detail, those skilled in the art should understand that they can make various changes, substitutions and alterations herein without departing from the spirit and scope of the invention in its broadest form.

What is claimed is:

1. A system for managing out-of-order memory access requests, comprising:
a shift register for containing memory addresses and associated request validity indicators corresponding to a plurality of memory access requests; and
control logic, coupled to said shift register, for modifying a validity indicator for a selected one of said memory access requests, said modifying causing said selected one of said memory access requests to be removed from said shift register.

2. The system as recited in claim 1 wherein said control logic causes said selected one of said memory access requests to be invalidated in said shift register.

3. The system as recited in claim 1 wherein said shift register at least partially shifts to replace said selected one of said memory access requests.

4. The system as recited in claim 1 wherein a memory associated with said system contains validity indicators corresponding to addressable locations therein.

5. The system as recited in claim 1 further comprising a memory request buffer, associated with said shift register, for containing data corresponding to said plurality of memory access requests.

6. The system as recited in claim 1 wherein said validity indicator is a one bit flag.

7. A method of managing out-of-order memory access requests, comprising:
storing memory addresses and associated request validity indicators corresponding to a plurality of memory access requests in a shift register; and
modifying a validity indicator for a selected one of said memory access requests, said modifying causing said selected one of said memory access requests to be removed from said shift register.

8. The method as recited in claim 7 wherein modifying causes said selected one of said memory access requests to be invalidated in said shift register.

9. The method as recited in claim 7 further comprising at least partially shifting said shift register to replace said selected one of said memory access requests.

10. The method as recited in claim 7 wherein a memory associated with said system contains validity indicators corresponding to addressable locations therein.

11. The method as recited in claim 7 further comprising storing data corresponding to said plurality of memory access requests in a memory request buffer associated with said shift register.

12. The method as recited in claim 7 wherein said validity indicator is a one bit flag.

13. A memory unit for managing out-of-order memory access requests, comprising:
a synchronous dynamic random access memory (SDRAM);
a shift register, coupled to said SDRAM, for containing memory addresses and associated request validity indicators corresponding to a plurality of memory access requests;
a memory request buffer, coupled to said shift register, for containing data corresponding to said plurality of memory access requests; and
control logic, coupled to said shift register, for modifying a validity indicator for a selected one of said memory access requests, said modifying causing said selected one of said memory access requests to be removed from said shift register.

14. The memory unit as recited in claim 13 wherein said control logic causes said selected one of said memory access requests to be invalidated in said shift register.

15. The memory unit as recited in claim 13 wherein said shift register at least partially shifts to replace said selected one of said memory access requests.

16. The memory unit as recited in claim 13 wherein a memory associated with said system contains validity indicators corresponding to addressable locations therein.

17. The memory unit as recited in claim 13 wherein said validity indicator is a one bit flag.
